(19) United States
(12) Patent Application Publication
(10) Pub. No.: US 2026/0014535 A1
(43) Pub. Date: Jan. 15, 2026

(54) DEVICE AND METHOD FOR METERING FLUID

(71) Applicant: SK On Co., Ltd., Seoul (KR)

(72) Inventors: Yeong Jun JI, Daejeon (KR); Ji Yun YANG, Daejeon (KR)

(21) Appl. No.: 19/267,650

(22) Filed: Jul. 14, 2025

(30) Foreign Application Priority Data
Jul. 15, 2024 (KR) 10-2024-0093217

(51) Int. Cl. B01F 35/88; B01F 35/221; B01F 35/71

(52) U.S. Cl. CPC B01F 35/883; B01F 35/2218; B01F 35/712; B01F 35/881

(57) ABSTRACT

Proposed is a fluid metering device including a mixer receiving fluid in a storage tank, a metering tank metering and supplying the fluid to the mixer, a first transfer device transferring the fluid from the storage tank to the metering tank, a second transfer device transferring an input of the metered fluid to the mixer, a sensor measuring a fluid mass in the metering tank, and a controller stopping the first transfer device and activating the second transfer device with the initial remaining fluid greater than the input, and allowing the second transfer device to transfer the amount of input from the metering tank to the mixer, based on the fluid mass from the sensor and preset first and second metering set values, so that it is possible to quickly input a desired amount of fluid step by step, and to precisely adjust a fluid input into a final process.

### CROSS REFERENCE TO RELATED APPLICATION

The present application claims priority to Korean Patent Application No. 10-2024-0093217, filed Jul. 15, 2024, the entire contents of which are incorporated herein for all purposes by this reference.

### TECHNICAL FIELD

The present disclosure relates to a fluid metering device and a fluid metering control method.

### BACKGROUND

Conventionally, flow meters are used to meter the amount of fluid, e.g., any solution, in a secondary battery mixing process. The mass of fluid input per batch is metered and controlled by flow meters installed in a pipe provided from a storage tank to an inputting point. The flow meters are configured to convert the amount of a certain solution, such as carboxymethyl cellulose (CMC) solution and binder solution, to the mass by a set specific gravity value. Therefore, if the solution deviates from the set specific gravity value, the mass of the solution may be inaccurate. This means that an error in specific gravity may eventually be reflected in the final stage of the mixing process and result in differences in the composition of produced slurry.

To achieve this, devices have recently been developed that utilize multiple fluid valves to finely adjust a flow rate of a fluid and utilize load cells to measure the mass of a fluid, thereby precisely measuring the fluid mass. With the growing interest and need for fluid mass measurements, research that can precisely and finely mix components of different solutions is proceeding actively.

### Document of Related Art

### Patent Document

(Patent Document 1) KR 2022-0056601 A

### SUMMARY

According to one aspect of the present disclosure, an objective is to provide a fluid metering device and a fluid metering control method, which are configured to quickly input a desired amount of a fluid step by step.

Another objective of the present disclosure is to provide a fluid metering device and a fluid metering control method, which are configured to finely adjust a fluid to be input into a final process.

A fluid metering device and a fluid metering control method, as described in the present disclosure, can be widely applied in electric vehicles, battery charging stations, and other green technologies, such as solar power and wind power, which utilize batteries. Furthermore, a fluid metering device and a fluid metering control method of the present disclosure can be utilized in eco-friendly electric vehicles and hybrid vehicles to prevent climate change by reducing air pollution and greenhouse gas emissions.

According to the present disclosure, there is provided a fluid metering device including: a mixer supplied with fluid in a storage tank; a metering tank metering the fluid supplied from the storage tank and supplying the fluid to the mixer; a first transfer device transferring the fluid from the storage tank to the metering tank; a second transfer device transferring an amount of input of the metered fluid from the metering tank to the mixer; a sensor installed at the metering tank and measuring a fluid mass of the fluid stored in the metering tank; and a controller, wherein when an amount of initial remaining fluid in the metering tank is greater than the amount of input, the controller stops the first transfer device and activates the second transfer device, and controls the second transfer device so that the second transfer device transfers the amount of input from the metering tank to the mixer, based on the fluid mass received from the sensor and preset first and second metering set values.

According to the embodiment, the controller may perform a first control operation to control the second transfer device so that the second transfer device may transfer the fluid in the metering tank to the mixer at a first fluid transfer rate until a first fluid mass that is a mass of current fluid stored in the metering tank reaches a second initial fluid mass value obtained by subtracting the first metering set value from a first initial fluid mass value that is a fluid mass value of the amount of initial remaining fluid when the first transfer device is stopped, and a second control operation to control the second transfer device so that the second transfer device may transfer the fluid in the metering tank to the mixer at a second fluid transfer rate until a second fluid mass that is a mass of current remaining fluid stored in the metering tank reaches a final fluid mass value obtained by subtracting the second metering set value from the second initial fluid mass value, wherein the first fluid transfer rate may be faster than the second fluid transfer rate.

According to the embodiment, the first control operation may be performed by inputting a portion of the amount of input from the metering tank to the mixer by the first metering set value at the first fluid transfer rate; and controlling the first fluid transfer rate to the second fluid transfer rate when it is determined that the first fluid mass reaches the second initial fluid mass value.

According to the embodiment, the second control operation may be performed by inputting a remaining portion of the amount of input from the metering tank to the mixer by the second metering set value at the second fluid transfer rate; and stopping the second transfer device when it is determined that the second fluid mass reaches the final fluid mass value.

According to the embodiment, the metering tank may further include a stirring device stirring the fluid in the metering tank after the amount of input is transferred from the metering tank to the mixer.

According to the embodiment, the fluid metering device may include: a first transfer tube configured to allow the fluid in the storage tank to flow from the storage tank to the metering tank by the first transfer device; and a second transfer tube configured to allow the amount of input to flow from the metering tank to the mixer by the second transfer device, and having a length 3 times to 100 times shorter than the first transfer tube.

According to the embodiment, the fluid metering device may further include: a circulation tube connected to the metering tank and the second transfer tube, wherein when the first transfer device is stopped, the second transfer device may circulate the fluid in the metering tank through the second transfer tube and the circulation tube, or recover the fluid remaining in the second transfer tube to the metering tank through the circulation tube, and a first end of the circulation tube may be connected to the metering tank, a second end of the circulation tube may be connected to the second transfer tube between the second transfer device and the mixer, and the second end may be made of a flexible tube.

According to the embodiment, the second transfer device may include: a diaphragm pump adjusting air pressure by movement of a pump film to transfer the fluid, or an inverter pump adjusting a rotating speed by revolution of a pump motor to transfer the fluid.

According to the embodiment, the fluid in the storage tank may be a material for secondary batteries.

According to the present disclosure, there is provided a fluid metering control method including: primarily transferring, by a first transfer device, fluid in a storage tank to a metering tank; primarily stopping the first transfer device when an amount of initial remaining fluid in the metering tank is greater than an amount of input transferred from the metering tank to a mixer, thereby stopping the transferring of the fluid from the storage tank to the metering tank; measuring, by a sensor installed at the metering tank, a fluid mass of the fluid stored in the metering tank; and secondarily transferring, by a second transfer device, the amount of input from the metering tank to the mixer, based on the fluid mass received from the sensor, and preset first and second metering set values.

According to the embodiment, the secondarily transferring of the amount of input may include primarily controlling the second transfer device so that the second transfer device may transfer the fluid in the metering tank to the mixer at a first fluid transfer rate, until a first fluid mass that is the mass of current fluid stored in the metering tank reaches a second initial fluid mass value obtained by subtracting the first metering set value from a first initial fluid mass value that is a fluid mass value of the amount of initial remaining fluid when the first transfer device is stopped, and secondarily controlling the second transfer device so that the second transfer device may transfer the fluid in the metering tank to the mixer at a second fluid transfer rate, until a second fluid mass that is the mass of current remaining fluid stored in the metering tank reaches a final fluid mass value obtained by subtracting the second metering set value from the second initial fluid mass value, wherein the first fluid transfer rate may be faster than the second fluid transfer rate.

According to the embodiment, the primarily controlling of the second transfer device may include: primarily inputting a portion of the amount of input from the metering tank to the mixer by the first metering set value at the first fluid transfer rate; and adjusting the first fluid transfer rate in the second fluid transfer rate when it is determined that the first fluid mass reaches the second initial fluid mass value.

According to the embodiment, the secondarily controlling of the second transfer device may include: secondarily inputting a remaining portion of the amount of input from the metering tank to the mixer by the second metering set value at the second fluid transfer rate; and secondarily stopping the second transfer device when it is determined that the second fluid mass reaches the final fluid mass value.

According to the embodiment, the fluid metering control method may further include: primarily circulating, by the second transfer device, the fluid in the metering tank via a second transfer tube and a circulation tube after the primarily stopping of the first transfer device and before the measuring of the fluid mass, wherein the second transfer tube may be connected to the metering tank and the mixer, and the circulation tube may be connected to the second transfer tube and the metering tank.

According to the embodiment, the fluid metering control method may further include: storing the fluid in the metering tank, after the secondarily transferring of the amount of input, wherein the storing of fluid may include: secondarily circulating, by the second transfer device, the fluid in the metering tank via a second transfer tube and a circulation tube; or recovering, by the second transfer device, remaining fluid in the second transfer tube to the metering tank via the circulation tube, and stirring, by a stirring device, the fluid in the metering tank, wherein the second transfer tube may be connected to the metering tank and the mixer, and the circulation tube may be connected to the second transfer tube and the metering tank.

According to the embodiment of the present disclosure, a desired amount of fluid can be quickly input step by step.

According to the embodiment of the present disclosure, a fluid input into a final process can be finely adjusted.

### BRIEF DESCRIPTION OF THE DRAWINGS

FIG. 1 is a configuration diagram illustrating an overall fluid metering device according to an embodiment.

FIG. 2 is a configuration diagram illustrating a metering tank and a mixer of the fluid metering device according to the embodiment.

FIG. 3 is a process flow diagram illustrating change in fluid mass in the metering tank of the fluid metering device according to the embodiment.

FIG. 4 is a block diagram illustrating a controller of the fluid metering device according to the embodiment.

FIG. 5 is a flowchart illustrating a fluid metering control method according to an embodiment.

### DETAILED DESCRIPTION

The above and other objectives, features, and advantages of the present disclosure will be more clearly understood from the following detailed description taken in conjunction with the accompanying drawings, and the disclosure is not limited to the embodiment disclosed herein. Furthermore, in the following description, if it is determined that the detailed description of a known function or configuration related to the disclosure makes the subject matter of the disclosure unclear, the detailed description is omitted.

Reference now should be made to the drawings, in which the same reference numerals are used throughout the different drawings to designate the same or similar components.

The terms used to describe an embodiment of the present disclosure are not intended to limit the disclosure. It should be understood that an element expressed in a singular form in this specification may be plural elements unless it is necessarily singular in the context.

The drawings may be shown schematically or exaggeratedly for the purpose of illustrating embodiments.

Hereinbelow, expressions such as “has”, “may have”, “includes”, or “may include” refer to the presence of a feature (e.g., a numerical value, function, operation, or component such as a part) and do not exclude the presence of additional features.

It will be understood that, although the terms “one side”, “the other side”, “first”, “second”, etc. may be used herein to describe various elements, these elements should not be limited by these terms.

The relative terms such as “upper”, “lower”, “left”, “right”, “X-axis”, “Y-axis”, and the like may be used for convenient description, and may be expressed differently depending on the position of an observer or the position of an object.

It should be understood that the exemplary embodiments according to the concept of the present disclosure are not limited to the embodiments which will be described hereinbelow with reference to the accompanying drawings, but various modifications, equivalents, additions, and substitutions are possible, without departing from the scope and spirit of the disclosure.

Hereinbelow, exemplary embodiments of the present disclosure will be described in detail with reference to the accompanying drawings, and the scope and spirit of the present disclosure are not limited to the specific embodiment described hereinbelow.

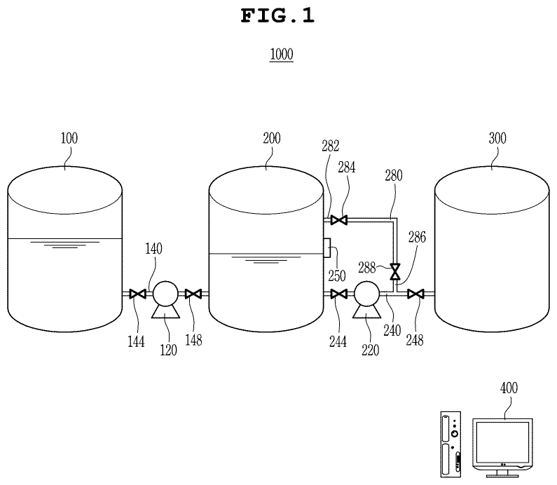

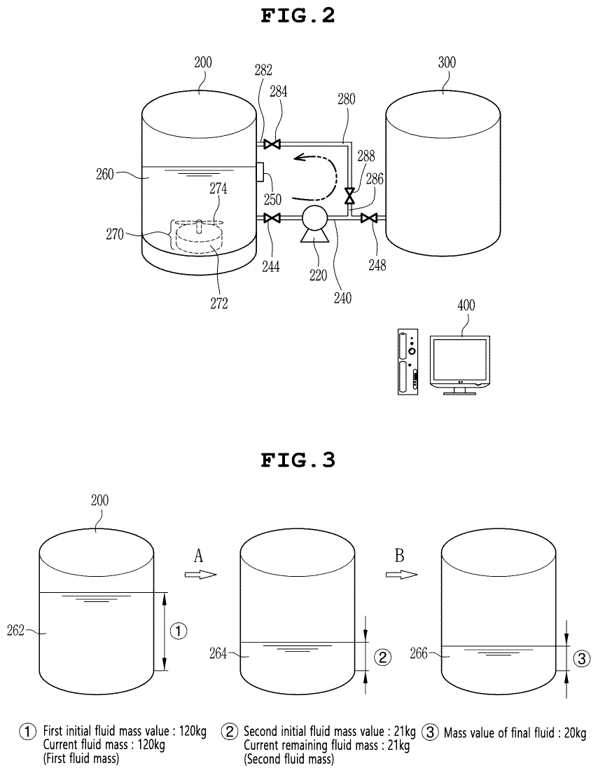

FIG. 1 is a configuration diagram illustrating an overall fluid metering device according to an embodiment. FIG. 2 is a configuration diagram illustrating a metering tank and a mixer of the fluid metering device according to the embodiment. Furthermore, FIG. 3 is a process flow diagram illustrating the change in fluid mass in the metering tank of the fluid metering device according to the embodiment.

Hereinbelow, the present disclosure is described with reference to FIGS. 1 to 3.

Referring to FIG. 1, the fluid metering device 1000 may include a storage tank 100 storing a fluid therein and a mixer 300 supplied with the fluid in the storage tank 100. Herein, the fluid may be a solution used as a material for secondary batteries, for example, which may include a carboxymethyl cellulose (CMC) solution and a binder solution. The solution may be a fluid with high viscosity, and the corresponding viscosity may range from 100 cp to 100,000 cp. For example, the viscosity may range from 100 cp to 15000 cp. However, the fluid having the above-described properties is only one example, and the fluid described in the specification may be replaced by various types of fluids that can be used in other industrial sites or production lines, without departing from the scope of the disclosure.

Furthermore, the fluid metering device 1000 may include a metering tank 200 that meters the fluid supplied from the storage tank 100 and supplies the fluid to the mixer 300.

The fluid metering device 1000 may include a first transfer device 120 and a second transfer device 220.

The first transfer device 120 may be a device used to transfer the fluid in the storage tank 100 to the metering tank 200. For example, the first transfer device 120 may be a pump that transfers fluid to the metering tank 200. The pump may include a reciprocating pump, a rotary pump, a centrifugal pump, and an axial flow pump, and without limitations thereto, may also include pressure devices with various shapes that can transfer fluid to the metering tank 200.

The second transfer device 220 may be a device used to transfer the amount of input of the fluid metered in the metering tank 200 to the mixer 300. For example, the second transfer device 220 may be a pump that transfers the fluid from the metering tank 200 to the mixer 300. Specifically, the second transfer device 220 may include a diaphragm pump that adjusts air pressure by movement of a pump film and transfers the fluid to the mixer 300. Furthermore, the second transfer device 220 may include an inverter pump that adjusts the rotating speed by revolution of the pump motor and transfers the fluid to the mixer 300. Furthermore, the second transfer device 220 may include a reciprocating pump, a rotary pump, a centrifugal pump, and an axial flow pump in addition to the above-proposed diaphragm pump and the inverter pump, and without limitations thereto, may also include pressure devices with various shapes that can transfer the fluid to the mixer 300.

Furthermore, when the first transfer device 120 is stopped, the second transfer device 220 may circulate the fluid in the metering tank 200 via a second transfer tube 240 and a circulation tube 280, or recover remaining fluid in the second transfer tube 240 to the metering tank 200 via the circulation tube 280.

Specifically, as shown in FIG. 2, the second transfer device 220 may circulate the fluid 260 in the metering tank 200 via the second transfer tube 240 and the circulation tube 280 in the arrow direction. For example, after the first transfer device 120 completes the transferring of the fluid from the storage tank 100 to the metering tank 200, and before the second transfer device 220 transfers the amount of input from the metering tank 200 to the mixer 300, the first transfer device 120 is stopped, and the second transfer device 220 may circulate the fluid 260 in the arrow direction. The fluid is then circulated, thereby preventing the fluid in the metering tank 200 from hardening.

Moreover, the second transfer device 220 may recover all remaining fluid in the second transfer tube 240 to the metering tank 200 via the circulation tube 280, except for supplying of fluid from the storage tank 100 to the metering tank 200 or metering of fluid from the metering tank 200 to the mixer 300. For example, when the first transfer device 120 does not supply the fluid from the storage tank 100 to the metering tank 200, or when the second transfer device 220 completes the transferring of the amount of input from the metering tank 200 to the mixer 300, the second transfer device 220 may recover the remaining fluid in the second transfer tube 240 to the metering tank 200.

The circulation tube 280 and the second transfer tube 240 will be described in detail below.

As described above, the second transfer device 220 not only transfers the amount of input from the metering tank 200 to the mixer 300, but also circulates the fluid in the metering tank 200 to prevent hardening of the fluid and recovers the remaining fluid in the second transfer tube 240, so the fluid metering device 1000 has advantage of not requiring a circulation device or a recovery device separately. Since there is no need for a circulation device or a recovery device and no need for a pipe used to connect the corresponding devices to the metering device, the second transfer tube 240 (when necessary, also the circulation tube 280) may be formed to be short. This may reduce the installation cost and prevent pressure change in the second transfer tube 240 (i.e., maintaining the fluid mass in the second transfer tube 240 evenly), thereby eliminating an error of the fluid mass to be metered in the metering tank 200.

The fluid metering device 1000 may include a first transfer tube 140 and the second transfer tube 240. The first transfer tube 140 and the second transfer tube 240 may include a pipe or a duct.

The first transfer tube 140 is connected to the storage tank 100 and the metering tank 200 and is configured to enable the fluid in the storage tank 100 to flow from the storage tank 100 to the metering tank 200 by the first transfer device 120. To this end, the first transfer device 120 may be installed in the first transfer tube 140. Furthermore, a first front-end adjusting valve 144 and a first rear-end adjusting valve 148 may be installed in a front end and a rear end of the first transfer tube 140 and adjust a flow rate flowing from the storage tank 100 to the metering tank 200.

The second transfer tube 240 is connected to the metering tank 200 and the mixer 300 and is configured to enable the fluid (i.e., the amount of input) in the metering tank 200 to flow from the metering tank 200 to the mixer 300. The second transfer device 220 may be installed in the second transfer tube 240. Furthermore, a second front-end adjusting valve 244 and a second rear-end adjusting valve 248 may be respectively installed at a front end and a rear end of the second transfer tube 240 and adjust a flow rate flowing from the metering tank 200 to the mixer 300.

The second transfer tube 240 may have a shorter length than the first transfer tube 140. When the second transfer tube 240 is long, the fluid mass in the second transfer tube 240 cannot remain constant, so the second transfer tube 240 may be designed as short as possible. For example, the second transfer tube 240 may have a length that is 3 to 100 times shorter, more preferably 5 to 15 times shorter, than the first transfer tube 140.

The fluid metering device 1000 may include a sensor 250. The sensor 250 may be installed in the metering tank 200, and for a certain period of time, measure the fluid mass of the fluid stored in the metering tank 200 in real time. For example, the sensor 250 includes a load cell that measures a force acting in the direction of gravity, a force sensor that measures a load generated in all direction, and a pressure transducer that measures a specific force as a pressure, and without limitations thereto, may include various types of sensing devices as long as they can measure the fluid mass.

Referring to FIGS. 1 and 2, the fluid metering device 1000 may include the circulation tube 280 that is connected to the metering tank 200 and the second transfer tube 240.

The circulation tube 280 may include a first end 282 connected to the metering tank 200 and a second end 286 connected to the second transfer tube 240. The second end 286 may be connected to the second transfer tube 240 between the second transfer device 220 and the mixer 300. The second end 286 may be connected to the rear end of the second transfer tube 240. For example, since the second end 286 is a start portion where the remaining fluid is recovered when the fluid remaining in the second transfer tube 240 is recovered due to operation of the second transfer device 220, adverse effects such as shaking and vibration of the circulation tube 280 may affect the second transfer tube 240. To minimize the adverse effects, the second end 286 of the circulation tube 280 may be made of a flexible pipe. A circulation front-end adjusting valve 284 and a circulation rear-end adjusting valve 288 may be respectively installed at the first end and the second end 282 and 286 and adjust the flow rate of the recovered fluid.

Referring to FIG. 2, the metering tank 200 may include a stirring device 270 that stirs the fluid 260 stored in the metering tank 200. The stirring device 270 may include a motor 272 and an impeller 274 that is rotated by the motor 272. Rotation of the impeller 274 may prevent the fluid 260 from hardening. Since the stirring device 270 may generate hunting or noise affecting the sensor 250, after the amount of input is transferred from the metering tank 200 to the mixer 300, i.e., the first and second transfer devices 120 and 220 are stopped, the stirring device may be operated. Eventually, the fluid 260 is stored in the metering tank 200 without operation of the first and second transfer devices 120 and 220, the stirring device 270 may be operated to prevent the fluid from hardening. The stirring device 270 functions similarly to the above-described fluid circulating operation of the second transfer device 220 and the circulation tube 280, thereby preventing the fluid in the metering tank 200 from hardening. Therefore, the metering tank 200 does not necessarily include the stirring device 270.

Furthermore, the fluid metering device 1000 may include a controller 400. The controller 400 may control the first and second transfer devices 120 and 220. Accordingly, the first and second transfer devices 120 and 220 may be selectively activated or stopped. For example, the controller 400 activates the first transfer device 120 and stops the second transfer device 220, stops the first transfer device 120 and activates the second transfer device 220, or stops the first and second transfer devices 120 and 220.

The controller 400 receives data about a general metering set value and a precision metering set value preset by a user and data about the fluid mass from the sensor 250, and may control the first and second transfer devices 120 and 220 according to the data. Accordingly, the controller 400 may control the amount of input of the fluid transferred from the metering tank 200 to the mixer 300.

Furthermore, before controlling the amount of input, the controller 400 may determine whether the amount of initial remaining fluid in the metering tank is greater than the amount of input.

When the controller 400 determines that the amount of initial remaining fluid in the metering tank 200 is smaller than the amount of input, the controller 400 may control the first transfer device 120 to successively transfer the fluid from the storage tank 100 to the metering tank 200 so that the amount of input is greater than the amount of initial remaining fluid.

When it is determined that the amount of initial remaining fluid in the metering tank 200 is greater than the amount of input, the controller 400 stops the first transfer device 120, and before the metering tank 200 starts metering, the controller 400 activates the second transfer device 220 to circulate the amount of initial remaining fluid in the metering tank 200 at a constant circulation speed through the circulation tube 280, thereby preventing the fluid in the metering tank 200 from hardening.

When the metering tank 200 starts metering, the controller 400 may control the second transfer device 220 so that the second transfer device 220 transfers the amount of input from the metering tank 200 to the mixer 300 step by step, based on the fluid mass received from the sensor 250 and the preset general metering set value and the precision metering set value. The stepped control of the second transfer device 220 enables the amount of input to be precisely and accurately input into the mixer 300.

To this end, the controller 400 may perform a first control operation and a second control operation.

The first control operation allows the second transfer device 220 to transfer the fluid in the metering tank 200 to the mixer 300 at the first fluid transfer rate, until a first fluid mass that is a fluid mass of the amount of currently stored fluid in the metering tank 200 reaches a second initial fluid mass value obtained by subtracting the general metering set value from a first initial fluid mass value that is a fluid mass value of the amount of initial remaining fluid when the first transfer device 120 is stopped. The first fluid transfer rate may be faster than the second fluid transfer rate, which will be described below.

The second control operation allows the second transfer device 220 to transfer the fluid in the metering tank 200 to the mixer 300 at the second fluid transfer rate, until the second fluid mass, which is a current fluid mass of remaining fluid in the metering tank 200 on a time point when the first control operation is stopped, reaches a final fluid mass value obtained by subtracting the precision metering set value from the second initial fluid mass value.

To describe the first control operation and second control operation in detail, it is assumed that the amount of input from the metering tank 200 to the mixer 300 is, for example, 100 kg. Accordingly, the user may preset an input value for the mass of the amount of input to be required, the general metering set value for the mass of a portion of the amount of input, which is primarily input from the metering tank 200 to the mixer 300, and the precision metering set value for the mass of a remaining portion of the amount of input, which is secondarily input from the metering tank 200 to the mixer 300. As described above, the input value, the general metering set value, and the precision metering set value may use mass units to facilitate easier metering.

The user may usually preset the general metering set value greater than the precision metering set value to fast transferring large volumes of fluid from the metering tank 200 to the mixer 300. At this point, for example, it is assumed that the user sets the general metering set value to 99 kg, and sets the precision metering set value (=input value-general metering set value) to 1 kg.

Furthermore, it is assumed that the first initial fluid mass value, which is a fluid mass value of the amount of initial remaining fluid in the metering tank 200 when the first transfer device 120 is stopped, is 120 kg. Then, the first fluid mass, which is the fluid mass of the current fluid stored in the metering tank 200, is also 120 kg, equal to the first initial fluid mass value of the amount of initial remaining fluid.

Referring to FIG. 3, the controller 400 may perform the first control operation in which the second transfer device 220 is controlled to transfer the fluid 262 stored in the metering tank 200 to the mixer 300 at the first fluid transfer rate, until 120 kg, which is the first fluid mass of the current fluid 262 stored in the metering tank 200 reaches the second initial fluid mass value (i.e., 120 kg-99 kg=21 kg) obtained by subtracting the general metering set value (i.e., 99 kg) from the first initial fluid mass value (i.e., 120 kg).

In other words, in the process indicated as the arrow A in FIG. 3, the controller 400 receives data about the fluid mass from the sensor 250 in real time, and the second transfer device may transfer the fluid 262 at the first fluid transfer rate, until the first fluid mass of 120 kg reaches the second initial fluid mass value (i.e., 21 kg). In the transfer process, the fluid 262 of the general metering set value (i.e., 99 kg) required by the user may be input into the mixer 300 at the first fluid transfer rate.

Eventually, in the first control operation, a portion of the amount of input may be input from the metering tank 200 to the mixer 300 by the general metering set value at the first fluid transfer rate.

Furthermore, the first control operation may be performed by adjusting the first fluid transfer rate to the second fluid transfer rate when the first fluid mass of 120 kg is reduced and reaches the second initial fluid mass value (i.e., 21 kg).

Thereafter, the controller 400 may perform the second control operation. At this point, the second fluid mass, which is the mass of the current remaining fluid 264 stored in the metering tank 200, may be 21 kg.

The second control operation is performed by controlling the second transfer device 220 to transfer the fluid 264 from the metering tank 200 to the mixer 300 at the second fluid transfer rate, until the second fluid mass of 21 kg, which is the mass of the current remaining fluid 264 stored in the metering tank 200, reaches the final fluid mass value (i.e., 20 kg), which is obtained by subtracting the precision metering set value (i.e., 1 kg) from the second initial fluid mass value (i.e., 21 kg).

In other words, in the process indicated as the arrow B in FIG. 3, the controller 400 receives data about the fluid mass from the sensor 250 in real time, and the second transfer device 220 may transfer the fluid 264 at the second fluid transfer rate, until the second fluid mass of 21 kg reaches the final fluid mass value (i.e., 20 kg) of final remaining fluid 266. In the transfer process, the fluid 264 of the precision metering set value (i.e., 1 kg) required by the user may be input into the mixer 300 at the second fluid transfer rate.

Eventually, in the second control operation, a remaining portion of the amount of input may be input from the metering tank 200 to the mixer 300 by the precision metering set value at the second fluid transfer rate.

Furthermore, in the second control operation, when the second fluid mass of 21 kg is reduced and reaches the final fluid mass value (i.e., 20 kg), the second transfer device 220 may be stopped.

As described above, the fluid metering device 1000 uses the general metering set value and the precision metering set value for the fluid mass in the metering tank 200, and the sensor 250 that can measure the fluid mass, so that the user can determine the amount of input from the metering tank 200 to the mixer 300 as the mass step by step. Therefore, since it is not necessary to use a separate instrument (e.g., adjustment valve) and separately meter or adjust the amount of input, there is no additional error caused by an instrument, and there is no need for the fluid specific gravity set value to obtain a mass value of the fluid, thereby eliminating errors caused from the specific gravity. Therefore, to precisely and conveniently produce the metered fluid by the user, the fluid metering device 1000 can enhance convenience as well as precisely and quickly meter the amount of input, step by step.

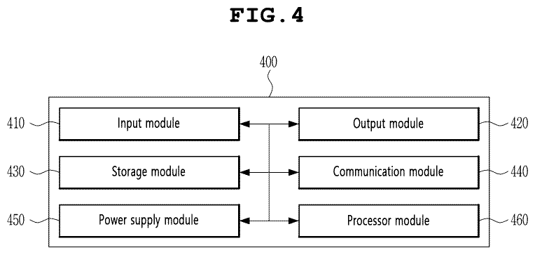

FIG. 4 is a block diagram illustrating a controller of the fluid metering device according to the embodiment.

The controller 400 may include a central processing unit (CPU), a graphics processing unit (GPU), various types of dedicated artificial intelligence (AI), computing chips, various computing units executing machine learning model algorithms, a digital signal processor (DSP) and any suitable processor, controller, microcontroller, etc., and may be various types of digital computers not limited thereto.

For example, the controller 400 may be a laptop computer, a desktop computer, a workbench, a personal digital assistant, a server, a blade server, a large computer, and other suitable computers. Furthermore, the controller 400 may be a mobile device having various forms, such as a personal digital assistant, cellular phone, smartphone, wearable device, and other similar computing devices.

The controller 400 may include an input module 410, an output module 420, a storage module 430, a communication module 440, a power supply module 450, and a processor module 460.

The input module 410 is used to input orders or data by the user, and may include a hard key, a soft key, a touch pad, a mouse, and the like. Furthermore, the input module 410 may have a form of a touch screen, same as the output module 420 described below. Accordingly, the input module 410 may receive the data about the general metering set value, the precision metering set value, and the amount of input that is the sum of the general metering set value and the precision metering set value, wherein the data is preset by the user.

The output module 420 outputs the data that is input and received, and may include light emitting diodes, displays, speakers, and the like. The output module 420 may notify the user with a notification when each device is operated or stopped. For example, the output module 420 may notify the user of the end time of the general metering and the end time of the precision metering with visual indications or auditory sounds. Furthermore, for example, the output module 420 may output the fluid transfer rate of the first and second transfer devices 120 and 220 and the fluid mass measured by the sensor 250.

The storage module 430 stores all data for managing and monitoring the process of inputting fluid from the storage tank 100 to the mixer 300 through the metering tank 200, for example, program code or executable instructions, data structures, program modules, and other data. The storage module 430 may include a hard disk, a magnetic disk, an optical disk, and the like.

The communication module 440 may communicate with the first and second transfer devices 120 and 220, the sensor 250, the stirring device 270, and the various adjustment valves 144, 148, 244, 248, 284, and 288 via wired and wireless communication. For example, the communication module 440 may receive and transmit data for each device. Specifically, the communication module 440 may transmit a measuring order to the sensor 250 to measure the fluid mass in the metering tank 200, and receive data of the measured fluid mass.

The power supply module 450 may supply power to each module of the controller 400 by using an external electrical power supply, such as an external electrical grid or external power source, or an internal electrical power supply, such as a built-in rechargeable battery.

The processor module 460 may be activated by reading program codes stored in the storage module 430. Accordingly, the processor module 460 may control the first and second transfer devices 120 and 220, the sensor 250, the stirring device 270, the various adjustment valves 144, 148, 244, 248, 284, and 288, and the like, according to the program codes, and manage and monitor the process of inputting the fluid from the storage tank 100 to the mixer 300 through the metering tank 200 in real time.

The processor module 460 may include an information processable device, such as central processing unit (CPU), programmable logic circuit (PLC), field programmable gate array (FPGA), application specific integrated circuit (ASIC), system on chip (SOC), complex programmable logic controller (CPLD), and the like.

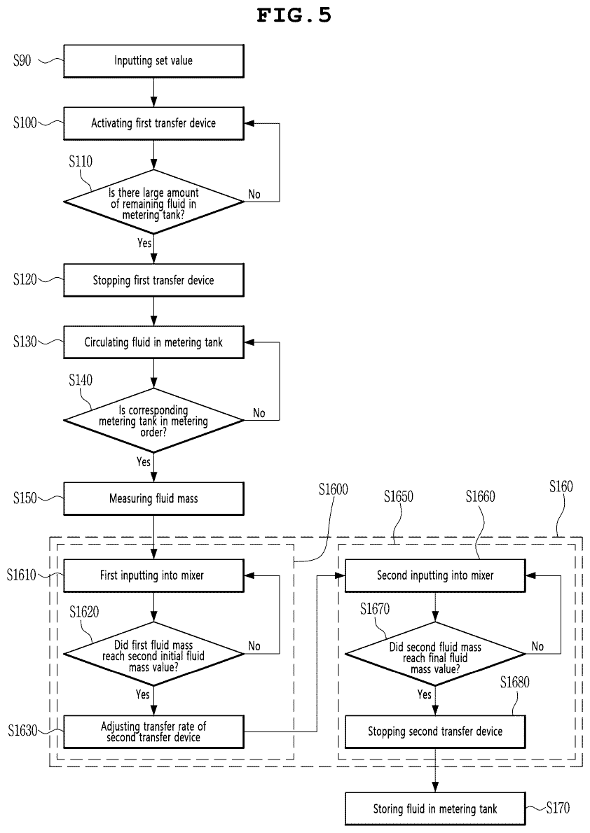

FIG. 5 is a flowchart illustrating a fluid metering control method according to an embodiment.

The fluid metering control method may include the input of a set value S90, the primary transfer of the fluid S100, the determination of the amount of a remaining portion in the metering tank S110, the primary stop of the first transfer device S120, the primary circulation of the fluid S130, the determination of the metering order S140, the measurement of the fluid mass S150, and the secondary transfer of the fluid S160.

First, in the input of a set value S90, the controller 400 may receive the input value, and the general metering set value and the precision metering set value preset by the user, for the amount of input that is input from the metering tank 200 to the mixer 300 by a preset flow rate.

In the primary transfer of the fluid S100, the controller 400 may activate the first transfer device 120, and the first transfer device 120 may transfer the fluid in the storage tank 100 to the metering tank 200.

In the determination of the amount of a remaining portion in the metering tank S110, the controller 400 may determine whether the amount of initial remaining fluid in the metering tank 200 is greater than the amount of input. When the controller 400 determines that the amount of initial remaining fluid in the metering tank 200 is smaller than the amount of input, the fluid metering control method proceeds to the primary transfer of the fluid S100 so that the first transfer device 120 may transfer the fluid from the storage tank 100 to the metering tank 200 successively.

In the determination of the amount of a remaining portion in the metering tank S110, when the controller 400 determines that the amount of initial remaining fluid in the metering tank is greater than the amount of input, the fluid metering control method proceeds to the primary stop of the first transfer device S120 so that the first transfer device 120 is stopped and the transferring of the fluid from the storage tank 100 to the metering tank 200 is stopped. Thereafter, the fluid metering control method proceeds to the primary circulation of the fluid S130, and the second transfer device 220 may be activated in the primary circulation of the fluid S130. In the primary circulation of the fluid S130, the second front-end adjusting valve 244, the circulation front-end adjusting valve 284, the circulation rear-end adjusting valve 288 are opened, and the second rear-end adjusting valve 248 is closed, which sets a circulation path connecting the second transfer tube 240 to the circulation tube 280, and the second transfer device 220 may circulate the fluid at a constant circulation speed along the circulation path to prevent the fluid in the metering tank 200 from hardening (e.g., referring to the arrow in FIG. 2).

In the determination of metering order S140, the controller 400 may determine whether it is the order in which the corresponding metering tank 200 meters the amount of input to be mixed in the mixer 300.

When it is the order of the metering tank 200 metering the amount of input to be mixed in the mixer 300, the fluid metering control method proceeds to the measurement of the fluid mass S150, and in the measurement of the fluid mass S150, the second transfer device 220 is stopped to stop the fluid circulation, and the sensor 250 may measure the fluid mass for the amount of initial remaining fluid. In the determination of metering order S140, when it is not the order of the metering tank 200 metering the amount of input to be mixed in the mixer 300, the fluid metering control method may proceed to the primary circulation of the fluid S130.

In the secondary transfer of the fluid S160, the controller 400 activates the second transfer device 220 again, the second transfer device 220 may transfer the amount of input from the metering tank 200 to the mixer 300, based on the fluid mass received from the sensor 250, and the general metering set value and the precision metering set value input into the controller

Specifically, the secondary transfer of the fluid S160 may include the primary control of the second transfer device S1600 and the secondary control of the second transfer device S1650.

In the primarily control of the second transfer device S1600, when the amount of initial remaining fluid in the metering tank 200 is greater than the amount of input (e.g., the first transfer device 120 is stopped), the controller 400 may control the second transfer device 220 so that the second transfer device 220 transfers the fluid 262 in the metering tank 200 to the mixer 300 at the first fluid transfer rate, until the first fluid mass, which is the mass of the current fluid 262 stored in the metering tank 200, reaches the second initial fluid mass value obtained by subtracting the general metering set value from the first initial fluid mass value, which is the fluid mass value of the amount of initial remaining fluid in the metering tank 200.

To this end, the primary control of the second transfer device S1600 may include the primary input of the fluid S1610, the primary determination S1620, and the adjustment of the transfer rate S1630.

In the primary input of the fluid S1610, the second transfer device 220 may input a portion of the amount of input from the metering tank 200 to the mixer 300 at the first fluid transfer rate by the general metering set value.

In the primary determination S1620, the controller 400 may determine whether or not the first fluid mass of the current fluid 262 stored in the metering tank 200 reaches the second initial fluid mass value obtained by subtracting the general metering set value from the first initial fluid mass value that is the fluid mass value of the amount of initial remaining fluid in the metering tank 200.

When the controller 400 determines that the first fluid mass reaches the second initial fluid mass value, the fluid metering control method proceeds to the adjustment of the transfer rate S1630, and in the adjustment of the transfer rate S1630, the controller 400 may adjust the first fluid transfer rate to the second fluid transfer rate. In the primary determination S1620, when the controller 400 determines that the first fluid mass does not reach the second initial fluid mass value, the fluid metering control method may proceed to the primary input of the fluid S1610.

The fluid metering control method may selectively include primary notification (not shown) between the primary determination S1620 and the adjustment of the transfer rate S1630. In the primary notification, when it is determined that the first fluid mass reaches the second initial fluid mass value, the controller 400 may notify the user that the general metering set value of the amount of input is primarily input from the metering tank 200 to the mixer 300. Accordingly, the user can directly recognize the end of general metering in the metering tank 200.

In the secondary control of the second transfer device S1650, the controller 400 may control the second transfer device 220 so that the second transfer device 220 transfers the fluid 264 in the metering tank 200 to the mixer 300 at the second fluid transfer rate, until the second fluid mass that is the mass of the current remaining fluid 264 stored in the metering tank 200 reaches the final fluid mass value obtained by subtracting the precision metering set value from the second initial fluid mass value.

To this end, the secondary control of the second transfer device S1650 may include the secondary input of the fluid S1660, the secondary determination S1670, and the secondary stop of the second transfer device S1680.

In the secondary input of the fluid S1660, the second transfer device 220 may input a remaining portion of the amount of input from the metering tank 200 to the mixer 300 at the second fluid transfer rate by the precision metering set value.

In the secondary determination S1670, the controller 400 may determine whether the second fluid mass, which is the mass of the current remaining fluid 264 stored in the metering tank 200, reaches the final fluid mass value obtained by subtracting the precision metering set value from the second initial fluid mass value.

When the controller 400 determines that the second fluid mass reaches the final fluid mass value, the fluid metering control method proceeds to the secondary stop of the second transfer device S1680, and in the secondary stop of the second transfer device S1680, the controller 400 may stop the second transfer device 220. In the secondary determination S1670, when the controller 400 determines that the second fluid mass does not reach the final fluid mass value, the fluid metering control method may proceed to the secondary input of the fluid S1660.

The fluid metering control method may selectively include secondary notification (not shown) between the secondary determination S1670 and the secondary stop of the second transfer device S1680. In the secondary notification, when it is determined that the second fluid mass reaches the final fluid mass value, the controller 400 may notify the user that the precision metering set value of the amount of input is secondarily input from the metering tank 200 to the mixer 300. Accordingly, the user can directly recognize the end of precise metering in the metering tank 200.

The fluid metering control method may include, after the secondary transfer of the fluid S160, the storage of fluid S170 to storing the fluid to prevent hardening of the fluid in the metering tank 200. The storage of fluid S170 may include the secondary circulation of the fluid or the stirring of fluid. In the secondary circulation of the fluid, similar to the primary circulation of the fluid S130, the second transfer device 220 is activated again and circulate the fluid in the metering tank 200 along the circulation path connecting the second transfer tube 240 to the circulation tube 280 at a constant circulation speed. In other words, the second transfer device may circulate the fluid in the metering tank through the second transfer tube and the circulation tube. Furthermore, in the stirring of fluid, the second transfer device 220 may recover the fluid remaining in the second transfer tube 240 to the metering tank 200 through the circulation tube 280, and the stirring device 270 may stir the fluid in the metering tank 200.

The above description is merely an example of the application of the principles of the present disclosure, and other configurations may be included without departing from the scope of the present disclosure.

Although the present disclosure has been described in detail with the specific embodiment, it is intended to illustrate the present disclosure in detail, and it will be apparent that modifications and improvements may be made by those skilled in the art within the technical ideas of the present disclosure.

All mere modifications, equivalents, or alternatives of the present disclosure fall within the scope of the present disclosure, and the specific scope of protection of the disclosure will be clearly defined by the appended claims.

What is claimed is:

1. A fluid metering device comprising:
a mixer supplied with fluid in a storage tank;
a metering tank metering the fluid supplied from the storage tank and supplying the fluid to the mixer;
a first transfer device transferring the fluid from the storage tank to the metering tank;
a second transfer device transferring an amount of input of the metered fluid from the metering tank to the mixer;
a sensor installed at the metering tank and measuring a fluid mass of the fluid stored in the metering tank; and
a controller, wherein when an amount of initial remaining fluid in the metering tank is greater than the amount of input, the controller stops the first transfer device and activates the second transfer device, and controls the second transfer device so that the second transfer device transfers the amount of input from the metering tank to the mixer, based on the fluid mass received from the sensor and preset first and second metering set values.

2. The fluid metering device of claim 1, wherein the controller performs
a first control operation to control the second transfer device so that the second transfer device transfers the fluid in the metering tank to the mixer at a first fluid transfer rate until a first fluid mass that is a mass of current fluid stored in the metering tank reaches a second initial fluid mass value obtained by subtracting the first metering set value from a first initial fluid mass value that is a fluid mass value of the amount of initial remaining fluid when the first transfer device is stopped, and
a second control operation to control the second transfer device so that the second transfer device transfers the fluid in the metering tank to the mixer at a second fluid transfer rate until a second fluid mass that is a mass of current remaining fluid stored in the metering tank reaches a final fluid mass value obtained by subtracting the second metering set value from the second initial fluid mass value,
wherein the first fluid transfer rate is faster than the second fluid transfer rate.

3. The fluid metering device of claim 2, wherein the first control operation is performed by
inputting a portion of the amount of input from the metering tank to the mixer by the first metering set value at the first fluid transfer rate; and
controlling the first fluid transfer rate to the second fluid transfer rate when it is determined that the first fluid mass reaches the second initial fluid mass value.

4. The fluid metering device of claim 3, wherein the second control operation is performed by
inputting a remaining portion of the amount of input from the metering tank to the mixer by the second metering set value at the second fluid transfer rate; and
stopping the second transfer device when it is determined that the second fluid mass reaches the final fluid mass value.

5. The fluid metering device of claim 1, wherein the metering tank further comprises a stirring device stirring the fluid in the metering tank after the amount of input is transferred from the metering tank to the mixer.

6. The fluid metering device of claim 1, comprising:
a first transfer tube configured to allow the fluid in the storage tank to flow from the storage tank to the metering tank by the first transfer device; and
a second transfer tube configured to allow the amount of input to flow from the metering tank to the mixer by the second transfer device, and having a length 3 times to 100 times shorter than the first transfer tube.

7. The fluid metering device of claim 6, further comprising:
a circulation tube connected to the metering tank and the second transfer tube,
wherein when the first transfer device is stopped, the second transfer device circulates the fluid in the metering tank through the second transfer tube and the circulation tube, or recovers the fluid remaining in the second transfer tube to the metering tank through the circulation tube, and
a first end of the circulation tube is connected to the metering tank, a second end of the circulation tube is connected to the second transfer tube between the second transfer device and the mixer, and the second end is made of a flexible tube.

8. The fluid metering device of claim 1, wherein the second transfer device comprises
a diaphragm pump adjusting air pressure by movement of a pump film to transfer the fluid, or an inverter pump adjusting a rotating speed by revolution of a pump motor to transfer the fluid.

9. The fluid metering device of claim 1, wherein the fluid in the storage tank is a material for secondary batteries.

10. A fluid metering control method comprising:
primarily transferring, by a first transfer device, fluid in a storage tank to a metering tank;
primarily stopping the first transfer device when an amount of initial remaining fluid in the metering tank is greater than an amount of input transferred from the metering tank to a mixer, thereby stopping the transferring of the fluid from the storage tank to the metering tank;
measuring, by a sensor installed at the metering tank, a fluid mass of the fluid stored in the metering tank; and
secondarily transferring, by a second transfer device, the amount of input from the metering tank to the mixer, based on the fluid mass received from the sensor, and preset first and second metering set values.

11. The fluid metering control method of claim 10, wherein the secondarily transferring of the amount of input comprises
primarily controlling the second transfer device so that the second transfer device transfers the fluid in the metering tank to the mixer at a first fluid transfer rate, until a first fluid mass that is the mass of current fluid stored in the metering tank reaches a second initial fluid mass value obtained by subtracting the first metering set value from a first initial fluid mass value that is a fluid mass value of the amount of initial remaining fluid when the first transfer device is stopped, and
secondarily controlling the second transfer device so that the second transfer device transfers the fluid in the metering tank to the mixer at a second fluid transfer rate, until a second fluid mass that is the mass of current remaining fluid stored in the metering tank reaches a final fluid mass value obtained by subtracting the second metering set value from the second initial fluid mass value,
wherein the first fluid transfer rate is faster than the second fluid transfer rate.

12. The fluid metering control method of claim 11, wherein the primarily controlling of the second transfer device comprises:
primarily inputting a portion of the amount of input from the metering tank to the mixer by the first metering set value at the first fluid transfer rate; and
adjusting the first fluid transfer rate to the second fluid transfer rate when it is determined that the first fluid mass reaches the second initial fluid mass value.

13. The fluid metering control method of claim 12, wherein the secondarily controlling of the second transfer device comprises:
secondarily inputting a remaining portion of the amount of input from the metering tank to the mixer by the second metering set value at the second fluid transfer rate; and
secondarily stopping the second transfer device when it is determined that the second fluid mass reaches the final fluid mass value.

14. The fluid metering control method of claim 10, further comprising:
primarily circulating, by the second transfer device, the fluid in the metering tank via a second transfer tube and a circulation tube after the primarily stopping of the first transfer device and before the measuring of the fluid mass,
wherein the second transfer tube is connected to the metering tank and the mixer, and the circulation tube is connected to the second transfer tube and the metering tank.

15. The fluid metering control method of claim 10, further comprising:
storing the fluid in the metering tank, after the secondarily transferring of the amount of input,
wherein the storing of fluid comprises:
secondarily circulating, by the second transfer device, the fluid in the metering tank via a second transfer tube and a circulation tube; or
recovering, by the second transfer device, remaining fluid in the second transfer tube to the metering tank via the circulation tube, and stirring, by a stirring device, the fluid in the metering tank,
wherein the second transfer tube is connected to the metering tank and the mixer, and the circulation tube is connected to the second transfer tube and the metering tank.
